(19) United States
(12) Patent Application Publication
(10) Pub. No.: US 2026/0061943 A1
(43) Pub. Date: Mar. 5, 2026

(54) Roof Trunk Locking Mechanism

(71) Applicant: ENROAD CO.,LTD, Jiangsu (CN)

(72) Inventors: Meng ZHANG, Jiangsu (CN); Guangshan WANG, Jiangsu (CN); Haiming TAN, Jiangsu (CN)

(73) Assignee: ENROAD CO.,LTD, Jiangsu (CN)

(21) Appl. No.: 19/308,451

(22) Filed: Aug. 25, 2025

(30) Foreign Application Priority Data
Aug. 30, 2024 (CN) 202422126533.6

(51) Int. Cl. B60R 9/048

(52) U.S. Cl. CPC B60R 9/048

(57) ABSTRACT

The present disclosure relates to a roof trunk locking mechanism, which belongs to the technical field of roof trunk fastening mechanisms. The locking mechanism is arranged at the front end of the roof trunk and is used to resist the lifting force generated by airflow acting on the front end of the trunk during high-speed vehicle travel. The locking mechanism comprises an upper locking hook and a lower locking mechanism, which are installed at the ends of the upper cover and the lower cover of the roof trunk and are engaged with each other. The lower locking mechanism comprises an unlocking linkage mechanism, which is linked to an unlocking operation member installed on the lateral surface of the roof trunk.

### CROSS-REFERENCE TO RELATED APPLICATIONS

This application claims the priority of the Chinese disclosure patent application No. 202422126533.6 filed on Aug. 30, 2024, the content of which is incorporated herein by reference in its entirety.

### TECHNICAL FIELD

The present disclosure relates to the technical field of roof trunk locking devices, specifically to a trunk roof trunk locking mechanism.

### BACKGROUND

Roof trunks are currently a relatively common type of roof equipment, and their closure and locking mechanisms are typically installed on the side of the trunk body. During emergency braking or acceleration of the vehicle, items inside the roof trunk may rapidly shift due to inertia, impacting the ends of the trunk. Since the ends of currently known roof trunks are generally not equipped with locking mechanisms, such impacts can easily cause the trunk to open, posing significant safety hazards. Moreover, during high-speed driving, the wind resistance generated as air flows over the front windshield and across the roof is obstructed by the roof trunk, causing high-speed airflow to create substantial lifting force at the ends of the trunk. This can force the originally closed trunk ends to open under the lifting force, severely compromising driving safety.

To address this, a locking mechanism installed at the end of the roof trunk is proposed.

### SUMMARY

The present disclosure provides a trunk roof trunk locking mechanism to solve the issues raised in the background art.

To achieve the above object, the present disclosure adopts the following technical

### Solution

A roof trunk locking mechanism comprises a roof trunk, comprising an upper cover and a lower cover; and a locking mechanism arranged at a front end of the roof trunk, configured to resist a lifting force generated by airflow acting on the front end of the trunk during high-speed vehicle travel. The locking mechanism comprises an upper locking hook and a lower locking mechanism that are installed at ends of the upper cover and the lower cover of the roof trunk and are engaged with each other. The lower locking mechanism comprises an unlocking linkage mechanism that is linked to an unlocking operation member installed on a lateral surface of the roof trunk.

The present disclosure further provides another technical solution: a roof trunk locking mechanism, comprising: a roof trunk, comprising an upper cover and a lower cover; and a locking mechanism arranged at a front end of the roof trunk, configured to resist a lifting force generated by airflow acting on the front end of the trunk during high-speed vehicle travel. The locking mechanism comprises: an upper locking hook arranged at an end of the upper cover and provided with a locking slot; and a lower locking mechanism arranged at an end of the lower cover and comprising: a locking assembly rotationally installed to engage with the locking slot; and a state maintaining assembly configured to restrict reset of the locking assembly during unlocking; and an unlocking assembly linked with an unlocking operation member installed on a lateral surface of the roof trunk. A bearing surface of the locking slot is inclined relative to a locking head of the locking assembly, enabling an external force to drive the locking head to move along an inclined surface, thereby increasing a locking force. When the unlocking assembly drives the locking assembly to disengage from the locking slot, the state maintaining assembly automatically locks a reset path of the locking assembly. Until the upper locking hook moves upward and disengages from the lower locking mechanism, the state maintaining assembly is triggered to release restriction.

The beneficial effects of the present disclosure compared to the prior art are:

The present disclosure is installed at the end of the roof trunk. Through the cooperation of the upper locking hook installed at the ends of the upper and lower covers and the lower locking mechanism, it can effectively lock the fastening structure at the end of the roof trunk. During vehicle travel, under non-active unlocking conditions, the lifting force generated by wind resistance or the jacking force from impacts will only make the engagement between the upper locking hook and the locking assembly tighter, achieving a stronger-locking effect under greater lifting force. This effectively prevents the trunk end from being forced open due to impacts or lifting forces caused by wind resistance, significantly enhancing the locking strength and safety between the upper and lower covers.

### BRIEF DESCRIPTION OF DRAWINGS

The drawings, which form part of this application, are provided to further illustrate the present disclosure. The illustrative embodiments and descriptions thereof are intended to explain the present disclosure and do not constitute an undue limitation of the present disclosure. In the drawings:

FIG. 1 is a schematic three-dimensional structural view of the assembled disclosure;

FIG. 2 is a first schematic exploded structural view of the present disclosure;

FIG. 3 is a second schematic exploded structural view of the present disclosure;

FIG. 4 is a schematic structural view of the unlocking pause assembly in the present disclosure;

FIG. 5 is a schematic structural view of the unlocking linkage mechanism in the present disclosure;

FIG. 6 is a schematic cross-sectional structural view of the present disclosure in the locked state;

FIG. 7 is a partial cross-sectional structural view showing the cooperation between the upper locking hook and the unlocking pause assembly in the present disclosure;

FIG. 8 is a schematic cross-sectional structural view of the present disclosure in the unlocked state;

FIG. 9 is a schematic cross-sectional structural view of the present disclosure in the semi-unlocked state;

FIG. 10 is a schematic structural view of the present disclosure after unlocking in practical application;

FIG. 11 is a schematic diagram of the structure after locking in practical application of the present disclosure.

Reference signs: 1, Upper locking hook; 101, Latch hook body; 102, Locking slot; 103, Release hook; 2, Lower locking mechanism; 201, Front cover; 211, Front main cover body; 212, Sliding groove; 213, Locking hole; 214, First assembly groove; 215, Second assembly groove; 216, Clamping groove; 202, Rear cover; 221, Rear main cover body; 222, Limiting member; 223, Clamping post; 224, Positioning stake; 203, Unlocking pause assembly; 231, Connecting part; 232, Guide post; 233, Reset locking stake; 234, Reset unlocking keycap; 235, First spring; 204, Locking assembly; 241, Sleeve cap; 242, Connecting arm; 243, Connecting head; 244, Limiting lug; 245, First pin post; 246, Second pin post; 247, Locking head; 205, Unlocking assembly; 251, Unlocking slider; 252, Connecting lug; 253, Spring seat; 254, Second spring; 255, Pull rope positioning groove; 3, Upper cover; 4, Lower cover; 5, Unlocking pull rope.

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

Currently, the ends of known roof trunks typically lack a locking mechanism, making them prone to opening upon impact. Additionally, during high-speed driving, the airflow passing over the vehicle's front windshield and roof is obstructed by the roof trunk, causing high-speed airflow to generate significant lifting force at the trunk's ends. This can force the closed ends to open under the lifting force, severely compromising driving safety. To address this, we propose a locking mechanism installed at the ends of the roof trunk. By coordinating the upper locking hook 1 on the upper cover 3 and the lower locking mechanism 2 on the lower cover 4, the locking assembly effectively secures the clasp structure at the trunk's ends. During driving, in a non-actively unlocked state of the upper locking hook 1 and the locking assembly 204, the lifting force from wind resistance or the lifting force from impact only tightens the engagement between the upper locking hook 1 and the locking assembly 204. This ensures that the locking effect between the upper cover 3 and the lower cover 4 strengthens with increasing lifting force, effectively preventing the trunk ends from being forced open by impact or wind resistance. This significantly enhances the locking strength and safety between the upper cover 3 and the lower cover 4. The specific solution is as follows:

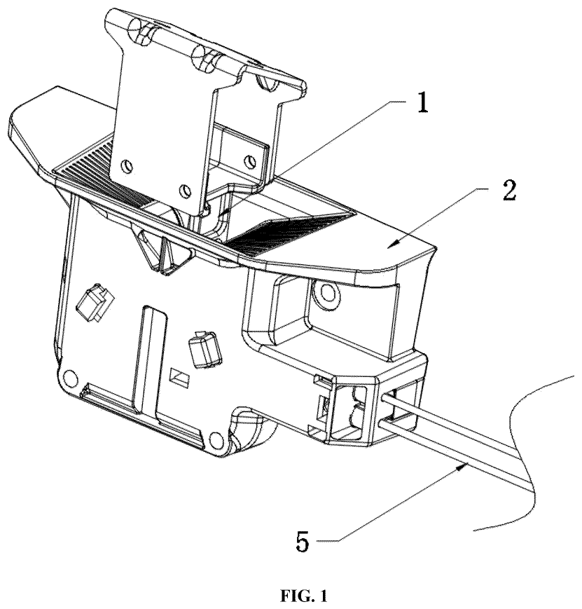

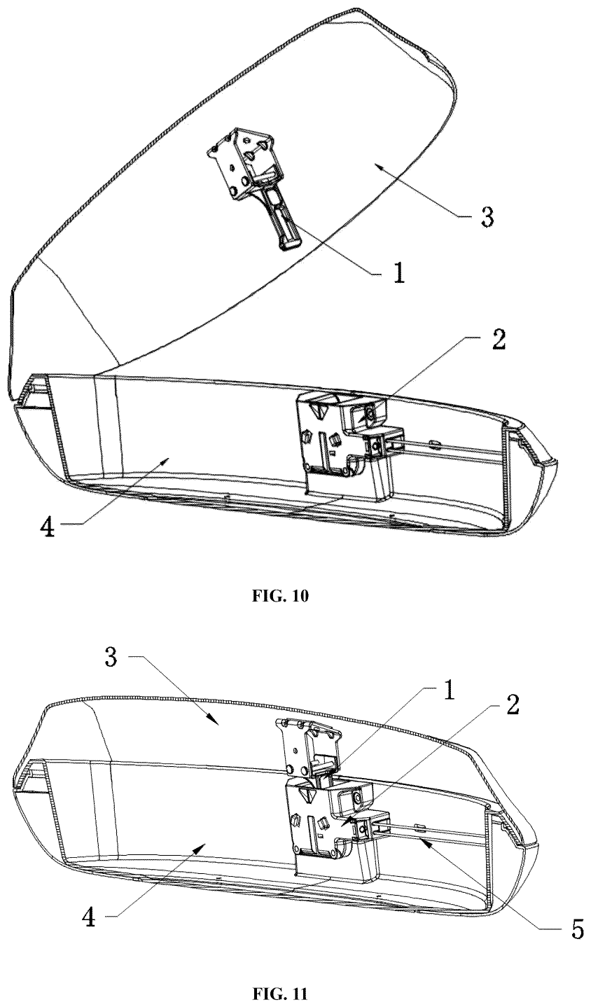

As shown in FIGS. 1, 10, and 11, the present disclosure discloses a roof trunk locking mechanism. The locking mechanism is installed at the front end of the roof trunk to counteract the lifting force generated by airflow acting on the trunk's front end during high-speed driving.

The locking mechanism includes the upper locking hook 1 and the lower locking mechanism 2, which are installed at the ends of the upper cover 3 and lower cover 4 of the roof trunk respectively, and work in coordination.

The lower locking mechanism 2 includes an unlocking linkage mechanism, which is linked to the unlocking operation member installed on the lateral surface of the roof trunk.

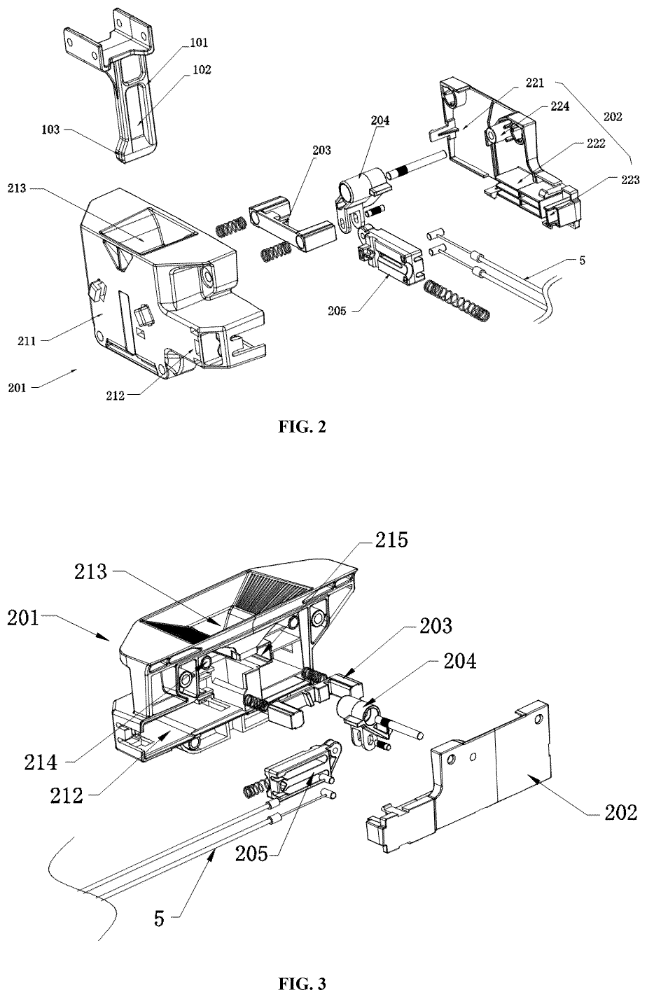

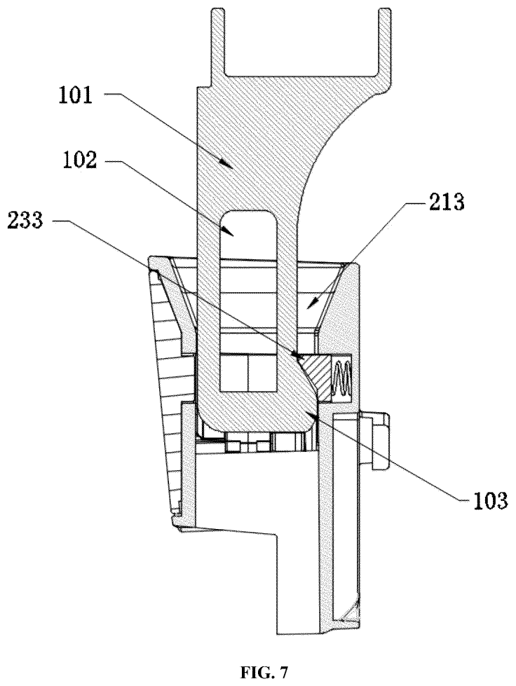

In this embodiment, as shown in FIGS. 2 and 7, to enable the upper locking hook 1 to are engaged with the lower locking mechanism 2 and achieve the locking operation of the upper and lower covers 4 of the roof trunk, the upper locking hook 1 specifically includes a latch hook body 101. A locking slot 102 is opened in the middle portion of the latch hook body 101, and a release hook 103 is provided at the bottom of the latch hook body 101, with both the upper and lower surfaces of the release hook 103 being inclined.

In this embodiment, as shown in FIGS. 2 and 3, the lower locking mechanism 2 further includes a front cover 201, a rear cover 202 and an unlocking pause assembly 203. The unlocking pause assembly 203 and the unlocking linkage mechanism are installed between the front cover 201 and the rear cover 202. Specifically, the unlocking linkage mechanism consists of a locking assembly 204 and an unlocking assembly 205. The unlocking assembly 205 is hinged to the locking assembly 204, while the locking assembly 204 is rotationally mounted between the front cover 201 and the rear cover 202 through a first pin post 245. The locking slot 102 is engaged with the locking assembly 204. The unlocking pause assembly 203 is transversely arranged on the lateral surface of the locking assembly 204, with the inclined surface of the release hook 103 close to the unlocking pause assembly 203, facilitating the unlocking pause assembly 203 to be triggered during the process of the upper locking hook 1 disengaging from the lower locking mechanism 2, thereby allowing the unlocking pause assembly 203 to reset to release the reset restriction on the locking assembly 204.

In other embodiments, the end of the unlocking assembly 205 is linked to the unlocking operation member installed on the lateral surface of the roof trunk through an unlocking pull rope 5. This locking mechanism is linked to the unlocking operation member on the lateral surface of the roof trunk through the unlocking pull rope 5, creating a certain angle between the locking mechanism and the unlocking operation member. Besides ensuring the operability of the roof trunk during opening, compared to the traditional design where the unlocking and locking mechanisms are aligned in a straight line, this design can increase the damping sensation during the unlocking operation, thereby enhancing the safety of the roof trunk after closure and locking.

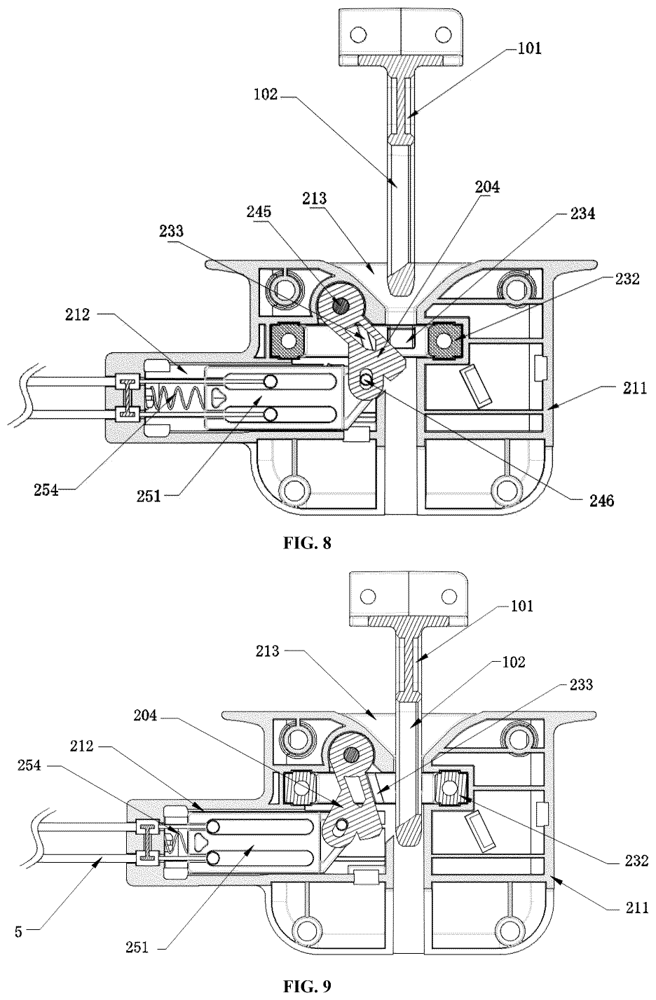

Among them, the unlocking pull rope 5 adopts a conventional hand-pull brake cable; the unlocking operation member uses a linkage lock, and the end of the steel wire in the unlocking pull rope 5 is fixedly connected to the unlocking pull rod in the linkage lock. The operator pulls the unlocking assembly 205 through the unlocking pull rope 5 by means of the unlocking operation member installed on the lateral surface of the roof trunk, causing the locking assembly 204 to disengage from the upper locking hook 1. At this point, the locking mechanism is in a semi-unlocked state, as shown in FIG. 9. Simultaneously, the unlocking pause assembly 203 limits the position of the locking assembly 204 to prevent the locking assembly 204 from resetting, eliminating the need for the operator to continuously maintain the unlocking operation on the unlocking operation member. When the upper cover 3 of the roof trunk is opened, the upper locking hook 1 drives the unlocking pause assembly 203 to reset during the process of disengaging from the lower locking mechanism 2. After the locking assembly 204 loses the restriction of the unlocking pause assembly 203, it resets under the push of the unlocking assembly 205, ready to automatically lock again once the upper locking hook 1 is re-engaged with the lower locking mechanism 2. At this point, the locking mechanism is in a fully unlocked state, as shown in FIG. 8.

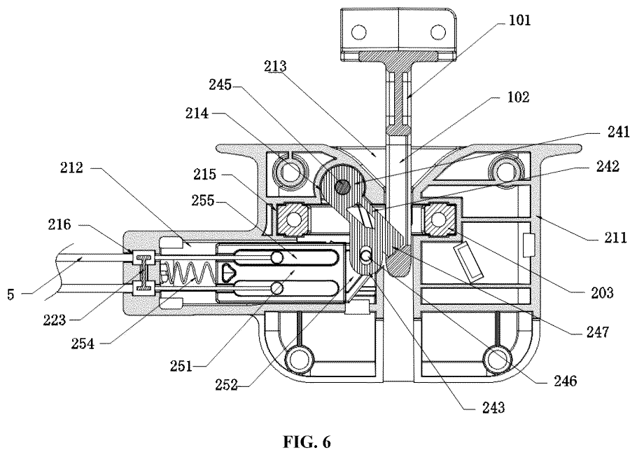

In other embodiments, as shown in FIG. 6, the front cover 201 includes a front main cover body 211. A locking hole 213, sized to match the upper locking hook 1, is integrally formed in the middle portion of the front main cover body 211 along the insertion direction of the upper locking hook 1. Additionally, a first assembly groove 214 for installing the locking assembly 204 and a second assembly groove 215 for installing the unlocking pause assembly 203 are integrally formed in the middle portion of the front main cover body 211, with the second assembly groove 215 located in the middle portion of the first assembly groove 214.

Among them, a sliding groove 212 for installing the unlocking assembly 205 is integrally formed on the inner side edge of the front main cover body 211, and a clamping groove 216 is provided at the end of the sliding groove 212 to secure the outer sleeve of the unlocking pull rope 5.

In other embodiments, to facilitate the effective assembly of the aforementioned front cover 201 with the unlocking pause assembly 203, locking assembly 204 and unlocking assembly 205, the rear cover 202 specifically includes a rear main cover body 221. On the rear main cover body 221, at a position corresponding to the first assembly groove 214, a positioning stake 224 is provided to secure the first pin post 245. Simultaneously, on the rear main cover body 221, at positions corresponding to the sliding groove 212 and the clamping groove 216, a limiting member 222 and a clamping post 223 are integrally formed respectively. Here, the limiting member 222, after the rear cover 202 is fastened with the front cover 201, slides against the surface of the unlocking assembly 205 without hindering its free movement within the sliding groove 212. Meanwhile, the clamping post 223 is engaged with the opening of the clamping groove 216 to prevent the clamping head at the end of the outer sleeve of the unlocking pull rope 5 from disengaging from the clamping groove 216. It should be noted that the interaction between the clamping post 223 and the clamping groove 216 does not compress the sleeve of the unlocking pull rope 5. Therefore, this design does not impede the movement of the internal steel wire of the unlocking pull rope 5 when driven by the unlocking operation member.

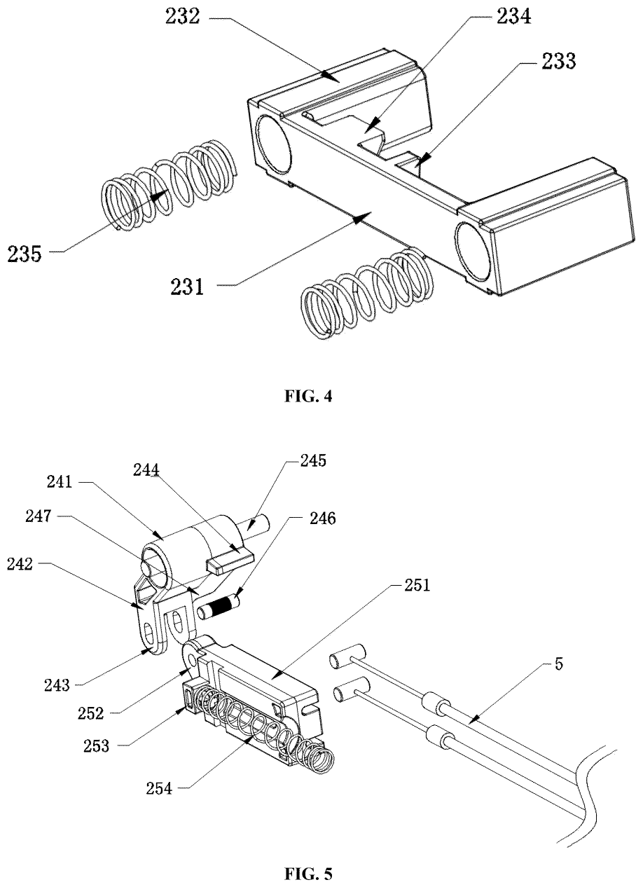

In other embodiments, as shown in FIG. 4, to enable the unlocking pause assembly 203 to release the lock on the upper locking hook 1 by the locking assembly 204 while simultaneously restricting the locking assembly 204 to maintain its unlocked state, the unlocking pause assembly 203 specifically includes a connecting part 231 and guide posts 232 integrally formed at both ends of the connecting part 231. The two guide posts 232 and the connecting part 231 form a U-shaped structure, with the locking assembly 204 positioned between the two guide posts 232. At the same time, the tail end of each guide post 232 is provided with a positioning hole for mounting a first spring 235. One end of the first spring 235 is fixed in the positioning hole, while the other end presses against the groove bottom of the second assembly groove 215. It should be further noted that the second assembly groove 215 is transversely designed on the front main cover body 211, and the unlocking pause assembly 203 is slidably assembled within it. Additionally, the side of the connecting part 231 adjacent to the locking assembly 204 is integrally formed with a reset locking stake 233 and a reset unlocking keycap 234. Under normal conditions, the reset locking stake 233 slidably fits against the lateral surface of the locking assembly 204. When the locking assembly 204 is rotated around the first pin post 245 by the pulling action of the unlocking assembly 205, disengaging it from the locking slot 102 in the upper locking hook 1, the locking assembly 204 moves away from the front of the reset locking stake 233 during this process. Meanwhile, the reset locking stake 233, driven by the first spring 235, moves forward along with the connecting part 231, blocking the reset path of the locking assembly 204 and placing the entire locking mechanism in a semi-unlocked state. The bottom of the reset unlocking keycap 234 is designed at an inclined angle and extends into the locking hole 213, aligning vertically with the release hook 103 at the bottom of the upper locking hook 1. As the upper locking hook 1 moves upward to disengage from the lower locking mechanism 2, the inclined upper surface of the release hook 103 on the latch hook body 101 presses against the inclined lower surface of the reset unlocking keycap 234. This action pushes the connecting part 231 and the positioning stake 224 backward to reset. At this point, the locking assembly 204, no longer obstructed by the reset locking stake 233, automatically resets under the action of the unlocking assembly 205, transitioning the locking mechanism from a semi-unlocked state to a fully unlocked state.

In other embodiments, as shown in FIG. 5, to enable automatic locking of the upper locking hook 1 in coordination with the unlocking assembly 205, the locking assembly 204 specifically includes a sleeve cap 241 fitted over the first pin post 245. A connecting arm 242 is integrally formed on the exterior of the sleeve cap 241, with one side of the front end of the connecting arm 242 extending forward to form a locking head 247 that is engaged with the locking slot 102. The bottom of the locking slot 102 is inclined toward the locking assembly 204. When the upper locking hook 1 is engaged with the locking assembly 204, the end face of the locking head 247 in the locking assembly 204 fits against the bottom of the locking slot 102. The front end of the connecting arm 242 is integrally formed with a U-shaped connecting head 243, which is provided with a strip-shaped assembly hole. The design of the strip-shaped assembly hole primarily prevents movement obstruction when the unlocking assembly 205 pulls the locking assembly 204 to rotate.

To prevent over-rotation of the locking assembly 204, a limiting lug 244 is also integrally formed on the exterior of the sleeve cap 241. The limiting lug 244 is engaged with the edge of the first assembly groove 214 to restrict the rotation angle of the connecting arm 242.

In other embodiments, as shown in FIG. 5, to enable the locking assembly 204 to release and lock the upper locking hook 1, the unlocking assembly 205 specifically includes an unlocking slider 251 slidably assembled in the sliding groove 212. The front end of the unlocking slider 251 is integrally formed with a perforated connecting lug 252, which, together with the second pin post 246, hinges the unlocking slider 251 to the connecting head 243 through the strip-shaped assembly hole. Meanwhile, the front side of the unlocking slider 251 is provided with a pull rope positioning groove 255 along the direction of the sliding groove 212. The end of the pull rope positioning groove 255 adjacent to the clamping groove 216 features a bayonet for easy passage of the unlocking pull rope 5. To ensure automatic reset of the locking assembly 204 and prevent unintended unlocking without external force after engagement with the upper locking hook 1, a spring seat 253 is integrally formed at the rear end of the unlocking slider 251 adjacent to the locking hole 213. A second spring 254 is installed between the spring seat 253 and the end of the sliding groove 212.

The steel wire at the front end of the unlocking pull rope 5 is fixed with a metal pin, which is secured in the pull rope positioning groove 255. The end of the outer sleeve of the unlocking pull rope 5 is clamped in the clamping groove 216.

In this embodiment (not shown), for an extra-long roof trunk, locking only at the front end may cause warping at the rear. The present disclosure addresses this by installing locking mechanisms at both the front and rear ends, achieving dual-side locking.

Specifically, the front locking mechanism is identical to the aforementioned embodiment, while the rear locking mechanism has the same structure but is oriented oppositely (the upper locking hook 1 is installed at the rear end of the lower cover 4, and the lower locking mechanism 2 is installed at the rear end of the upper cover 3). The unlocking operation members on both sides are interconnected through the same unlocking pull rope 5: a branch is set at the middle portion of the rope, connecting to the unlocking assemblies 205 at the front and rear ends, ensuring synchronous unlocking of both locking mechanisms when the operation member is pulled. In the unlocking pause assembly 203 of the rear locking mechanism, the first spring 235 has a 20% higher tension than the front end (ensuring the rear end resets and locks first to avoid uneven force distribution). When closing the trunk, the front upper locking hook 1 is engaged with the lower locking mechanism 2 first, while the rear end aligns under the weight of the cover, allowing automatic locking between the upper locking hook 1 and the lower locking mechanism 2. During unlocking, both sides disengage simultaneously, preventing cover deformation due to unilateral force.

In this embodiment (not shown in the figure), to enhance operational convenience, especially for large roof trunks, the mechanical linkage of “unlocking pull rope 3+manual operation member” is replaced with electric drive. The unlocking pull rope 5 is substituted with a miniature linear actuator, and the roof trunk is equipped with a controller and touch buttons installed on its side.

Among them, the cylinder of the miniature linear actuator is fixed at the tail end of the sliding groove 212 of the front cover 201, the rod end is fixedly connected to the unlocking slider 251 of the unlocking assembly 205, the controller is integrated on the inner side of the rear cover 202, electrically connected to both the touch button and the linear actuator, and has a built-in delay module. The second spring 254 on the back of the unlocking slider 251 retains its original design for resetting after the linear actuator is powered off. Pressing the touch button drives the linear actuator to extend, pushing the unlocking slider 251 to slide along the sliding groove 212, causing the locking assembly 204 to rotate around the first pin post 245 and disengage from the locking slot 102 of the upper locking hook 1 (same as the semi-unlocked state). The delay module triggers (with a 3-5 second delay, adapting to the user's time to open the upper cover), the linear actuator powers off, and the second spring 254 pulls the unlocking slider 251 to reset. If the upper locking hook 1 has already disengaged from the lower locking mechanism 2 at this point, the locking assembly 204 automatically resets (fully unlocked); if not, the unlocking pause assembly 203 remains in place to limit movement until the upper cover is opened to trigger the reset.

Electric drive reduces manual operating force, adapting to different user groups (e.g., women, elderly), while the delay design avoids energy waste caused by continuous motor operation.

In this embodiment (not shown in the figure), to prevent accidental unlocking caused by unintentional contact with the unlocking operation member during driving, an anti-misoperation safety structure is added. A sliding cover safety mechanism is added outside the unlocking operation member (linkage lock/knob): the safety cover is installed around the operation member through sliding rails, normally covering it. Sliding the safety cover exposes the operation member. A bump is provided on the inner side of the safety cover, corresponding to a recess on the side of the luggage compartment. When the safety cover is closed, the bump engages the recess, requiring a force of 5 N or more to slide (avoiding triggering caused by bumps). In the unlocking linkage mechanism, a damping pad (friction coefficient 0.3) is added between the unlocking slider 251 and the sliding groove 212 to ensure continuous force is required for unlocking, with automatic reset upon release (assisting anti-misoperation). Through dual protection of “safety cover+damping,” the probability of accidental unlocking is reduced, enhancing driving safety.

In summary, from the above description, it can be seen that the present disclosure achieves the following technical effects:

The present disclosure is installed at the end of a roof trunk. Through the cooperation between the upper locking hook 1 mounted on the ends of the upper cover 3 and lower cover 4 and the lower locking mechanism 2, it effectively locks the fastening structure at the end of the roof trunk. During vehicle movement, under non-active unlocking conditions, the lifting force generated by wind resistance or the jacking force caused by impacts only tightens the engagement between the upper locking hook 1 and the locking assembly 204, enhancing the locking effect between the upper cover 3 and lower cover 4. This achieves a “stronger under greater force” outcome, where increased lifting force results in tighter locking, effectively preventing the trunk end from being forced open due to impacts or wind-induced lifting forces. It significantly improves the locking strength and safety between the upper and lower covers.

In the present disclosure, the locking mechanism is linked to the unlocking operation member on the lateral surface of the roof trunk through the unlocking pull rope 5, creating an angle between the locking mechanism and the unlocking operation member. Compared to traditional designs where the unlocking and locking mechanisms are aligned in a straight line, this configuration maintains operational ease when opening the roof trunk while adding damping during the unlocking process, thereby enhancing safety after the trunk is closed and locked.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A roof trunk locking mechanism, comprising:
a roof trunk, comprising an upper cover and a lower cover; and
a locking mechanism arranged at a front end of the roof trunk, configured to resist a lifting force generated by airflow acting on the front end of the trunk during high-speed vehicle travel;
wherein the locking mechanism comprises an upper locking hook and a lower locking mechanism that are installed at ends of the upper cover and the lower cover of the roof trunk and are engaged with each other; and
the lower locking mechanism comprises an unlocking linkage mechanism that is linked to an unlocking operation member installed on a lateral surface of the roof trunk.

2. The roof trunk locking mechanism according to claim 1, wherein the lower locking mechanism further comprises a front cover, a rear cover and an unlocking pause assembly, with the unlocking pause assembly and the unlocking linkage mechanism installed between the front cover and the rear cover; and
the unlocking linkage mechanism comprises a locking assembly and an unlocking assembly hinged to the locking assembly, the locking assembly is rotationally installed between the front cover and the rear cover, and the unlocking pause assembly is transversely arranged on a lateral surface of the locking assembly.

3. The roof trunk locking mechanism according to claim 2, wherein the upper locking hook comprises a latch hook body, with a locking slot formed in a middle portion of the latch hook body to engage with the locking assembly, and a release hook with inclined upper and lower surfaces is provided at a bottom of the latch hook body adjacent to the unlocking pause assembly.

4. The roof trunk locking mechanism according to claim 3, wherein the front cover comprises a front main cover body, a locking hole adapted to a size of the upper locking hook is integrally formed in a middle portion of the front main cover body along an insertion direction of the upper locking hook, and a first assembly groove and a second assembly groove for respectively installing the locking assembly and the unlocking pause assembly are further integrally formed in the middle portion of the front main cover body; and
an inner side edge of the front main cover body is further integrally formed with a sliding groove for installing the unlocking assembly, the unlocking assembly is linked to the unlocking operation member through an unlocking pull rope, and an end of the sliding groove is provided with a clamping groove to fix an outer sleeve of the unlocking pull rope; and
the rear cover comprises a rear main cover body, the rear main cover body is provided with a positioning stake for fixing a first pin post at a position corresponding to the first assembly groove, and the rear main cover body is integrally formed with a limiting member and a clamping post at positions corresponding to the sliding groove and the clamping groove respectively.

5. The roof trunk locking mechanism according to claim 4, wherein the unlocking pause assembly comprises a connecting part and guide posts integrally formed at both ends of the connecting part, with a positioning hole provided at a tail end of each guide post for installing a first spring; the second assembly groove is transversely designed on the front main cover body, the unlocking pause assembly is slidably assembled in the second assembly groove, and the other end of the first spring abuts against a groove bottom of the second assembly groove; and
a side of the connecting part adjacent to the locking assembly is integrally formed with a reset locking stake and a reset unlocking keycap respectively, and under normal conditions, the reset locking stake slides against the lateral surface of the locking assembly, a bottom of the reset unlocking keycap is designed at an inclined angle, and the reset unlocking keycap extends into the locking hole and aligns vertically with the release hook at a bottom of the upper locking hook.

6. The roof trunk locking mechanism according to claim 4, wherein the locking assembly is rotatably installed between the front cover and the rear cover through the first pin post, and the locking assembly comprises a sleeve cap fitted over the first pin post; a connecting arm is integrally formed on an exterior of the sleeve cap, wherein one side of a front end of the connecting arm extends forward to form a locking head that is engaged with the locking slot, and a U-shaped connecting head is integrally formed downward at the front end of the connecting arm, with a strip-shaped assembly hole provided on the connecting head; and
a limiting lug is further integrally formed on the exterior of the sleeve cap, and the limiting lug is engaged with a groove edge of the first assembly groove to restrict a rotation angle of the connecting arm.

7. The roof trunk locking mechanism according to claim 6, wherein the unlocking assembly comprises an unlocking slider slidably assembled in the sliding groove, a front end of the unlocking slider is integrally formed with a connecting lug with a hole, and the unlocking slider is hinged to the connecting head through the connecting lug, a second pin post and the strip-shaped assembly hole; and
a front side of the unlocking slider is provided with a pull rope positioning groove along a direction of the sliding groove, and an end of the pull rope positioning groove adjacent to the clamping groove is provided with a bayonet for easy passage of the unlocking pull rope; and
a back side of the unlocking slider adjacent to the locking hole is integrally formed with a spring seat, and a second spring is installed between the spring seat and a tail end of the sliding groove.

8. The roof trunk locking mechanism according to claim 4, wherein the unlocking pull rope adopts a conventional hand-pull brake cable, with a metal pin fixed at a front end of a steel wire in the unlocking pull rope; the metal pin at the front end of the unlocking pull rope is clamped in the pull rope positioning groove, and an end of the outer sleeve end of the unlocking pull rope is clamped in the clamping groove

9. The roof trunk locking mechanism according to claim 1, wherein the unlocking operation member adopts a linkage lock, and a tail end of the steel wire in the unlocking pull rope is fixedly connected to an unlocking pull rod in the linkage lock.

10. The roof trunk locking mechanism according to claim 6, wherein a bottom of the locking slot is inclined toward the locking assembly, and when the upper locking hook is engaged with the locking assembly, an end face of the locking head in the locking assembly fits against the bottom of the locking slot.

11. A roof trunk locking mechanism, comprising:
a roof trunk, comprising an upper cover and a lower cover; and
a locking mechanism arranged at a front end of the roof trunk, configured to resist a lifting force generated by airflow acting on the front end of the trunk during high-speed vehicle travel;
wherein the locking mechanism comprises:
an upper locking hook arranged at an end of the upper cover and provided with a locking slot; and
a lower locking mechanism arranged at an end of the lower cover and comprising:
a locking assembly rotationally installed to engage with the locking slot; and
a state maintaining assembly configured to restrict reset of the locking assembly during unlocking; and
an unlocking assembly linked with an unlocking operation member installed on a lateral surface of the roof trunk;
wherein a bearing surface of the locking slot is inclined relative to a locking head of the locking assembly, enabling an external force to drive the locking head to move along an inclined surface, thereby increasing a locking force; and
when the unlocking assembly drives the locking assembly to disengage from the locking slot, the state maintaining assembly automatically locks a reset path of the locking assembly; and
until the upper locking hook moves upward and disengages from the lower locking mechanism, the state maintaining assembly is triggered to release restriction.

12. The roof trunk locking mechanism according to claim 11, wherein the lower locking mechanism further comprises a front cover and a rear cover; and
the locking assembly is rotationally installed between the front cover and the rear cover.

13. The roof trunk locking mechanism according to claim 12, wherein the state maintaining assembly is a sliding unlocking pause assembly transversely arranged on a lateral surface of the locking assembly.

14. The roof trunk locking mechanism according to claim 13, wherein the unlocking pause assembly comprises a connecting part and guide posts integrally formed at both ends of the connecting part, with a positioning hole provided at a tail end of each guide post for installing a first spring; and
a side of the connecting part adjacent to the locking assembly is integrally formed with a reset locking stake and a reset unlocking keycap, and under normal conditions, the reset locking stake slides against the lateral surface of the locking assembly, and a bottom of the reset unlocking keycap is designed at an inclined angle.

15. The roof trunk locking mechanism according to claim 14, wherein the upper locking hook comprises a latch hook body, with a locking slot formed in a middle portion of the latch hook body to engage with the locking assembly, and a release hook with inclined upper and lower surfaces is provided at a bottom of the latch hook body adjacent to the unlocking pause assembly.

16. The roof trunk locking mechanism according to claim 15, wherein the front cover comprises a front main cover body, with the second assembly groove transversely designed on the front main cover body; a locking hole adapted to a size of the upper locking hook is integrally formed in a middle portion of the front main cover body along an insertion direction of the upper locking hook, and a first assembly groove and a second assembly groove for respectively installing the locking assembly and the unlocking pause assembly are further integrally formed in the middle portion of the front main cover body; and
the unlocking pause assembly is slidably assembled in the second assembly groove, and the other end of the first spring abuts against a groove bottom of the second assembly groove; and
the reset unlocking keycap extends into the locking hole and aligns vertically with the release hook at a bottom of the upper locking hook.

17. The roof trunk locking mechanism according to claim 16, wherein a sliding groove for installing the unlocking assembly is integrally formed on an inner side of the front main cover body, the unlocking assembly is linked to the unlocking operation member through an unlocking pull rope, and a clamping groove is provided at a tail end of the sliding groove to secure an outer sleeve of the unlocking pull rope; and
the rear cover comprises a rear main cover body, with a positioning stake for fixing a first pin post provided at a position corresponding to the first assembly groove on the rear main cover body, and a limiting member and a clamping post are integrally formed on the rear main cover body at positions corresponding to the sliding groove and the clamping groove respectively.

18. The roof trunk locking mechanism according to claim 12, wherein the locking assembly is rotationally installed between the front cover and the rear cover through the first pin post; the locking assembly comprises a sleeve cap fitted over the first pin post, with a connecting arm integrally formed on an exterior of the sleeve cap, wherein one side of a front end of the connecting arm extends forward to form a locking head that is engaged with the locking slot, and a U-shaped connecting head is integrally formed downward at the front end of the connecting arm, with a strip-shaped assembly hole provided on the connecting head; and
a limiting lug is further integrally formed on the exterior of the sleeve cap, and the limiting lug is engaged with a groove edge of the first assembly groove to restrict a rotation angle of the connecting arm.

19. The roof trunk locking mechanism according to claim 17, wherein the unlocking pull rope adopts a conventional hand-pull brake cable, with a metal pin fixed at a front end of a steel wire in the unlocking pull rope; the metal pin at the front end of the unlocking pull rope is clamped in the pull rope positioning groove, and an end of the outer sleeve end of the unlocking pull rope is clamped in the clamping groove.

20. The roof trunk locking mechanism according to claim 19, wherein the unlocking operation member adopts a linkage lock, and a tail rear end of the steel wire in the unlocking pull rope is fixedly connected to the unlocking pull rod in the linkage lock.
